(19) United States
(12) Patent Application Publication
(10) Pub. No.: US 2025/0097268 A1
(43) Pub. Date: Mar. 20, 2025

(54) UNIFIED SECURITY GRAPH

(71) Applicant: Microsoft Technology Licensing, LLC, Redmond, WA (US)

(72) Inventors: Chen LAHAV, Givatayim (IL); Idan HEN, Tel Aviv (IL); Smadar CARMEL, Herzliya (IL)

(73) Assignee: Microsoft Technology Licensing, LLC, Redmond, WA (US)

(21) Appl. No.: 18/467,619

(22) Filed: Sep. 14, 2023

(51) Int. Cl. H04L 9/40

(52) U.S. Cl. CPC H04L 63/20; H04L 63/10; H04L 63/1433

(57) ABSTRACT

A computing system comprises one or more processors configured to obtain two or more security graphs that at least partially overlap. Each security graph comprises a plurality of nodes and at least one edge. The at least one edge represents a potential security vulnerability. Each node is classified as a permission scope node or a floating node. Each of the permission scope nodes is sorted into a respective permission scope profile. For each floating node that matches another floating node, such matching floating nodes are unified into a unified floating node. A set of edges that connects the sorted permission scope nodes and the unified floating nodes is defined based on the at least one edge of each security graph of the two or more security graphs. An interconnected security graph is output comprising the sorted permission scope nodes, the unified floating nodes, and the set of edges.

### BACKGROUND

A security graph comprises a graphical representation of interconnected relationships and dependencies among various elements within a network or system. The security graph can illustrate interactions between devices, users, applications, and data structures, helping security professionals identify vulnerabilities, monitor access, and detect anomalous activities. By visualizing these connections, security graphs enable rapid and comprehensive understanding of the system or the network's security posture, facilitating threat detection, incident response, and implementation of effective security policies and controls.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to methods and devices for generating an interconnected security graph from two or more security graphs that at least partially overlap. Each security graph comprises a data structure defining a plurality of nodes and at least one edge that connects two or more of the plurality of nodes. The at least one edge represents a potential security vulnerability between the two or more nodes. Each node of the plurality of nodes of the two or more security graphs is classified as a permission scope node or a floating node. Each of the permission scope nodes is sorted into a respective permission scope profile. For each floating node that matches another floating node, such matching floating nodes are unified into a unified floating node. A set of edges that connects the sorted permission scope nodes and the unified floating nodes is defined based on the at least one edge of each security graph of the two or more security graphs. An interconnected security graph is output comprising the sorted permission scope nodes, the unified floating nodes, and the set of edges.

### BRIEF DESCRIPTION OF THE DRAWINGS

FIG. 1 shows an example of a computing system configured to generate an interconnected security graph.

FIG. 2 shows an example of a security graph comprising a plurality of permission scope nodes and a floating node.

FIG. 3 shows an example of an interconnected security graph that can be output by the computing system of FIG. 1.

FIG. 4 shows an example of a restricted security graph that is based on the interconnected security graph of FIG. 3.

FIG. 5 shows another example of an interconnected security graph that can be output by the computing system of FIG. 1.

FIG. 6 shows an example of a restricted security graph that is based on the interconnected security graph of FIG. 5.

FIG. 7 shows another example of a restricted security graph that is based on the interconnected security graph of FIG. 5.

FIGS. 8A-8B show a flow diagram of an example method for generating an interconnected security graph.

FIG. 9 shows a schematic diagram illustrating an example computing system that can be used to implement the computing system of FIG. 1.

### DETAILED DESCRIPTION

As introduced above, a security graph comprises a graphical representation of interconnected relationships and dependencies among various elements within a network or system. The term “graphical representation” can generally refer to a representation of one or more entities, and any relationship(s) between the one or more entities, in graph form. In some examples, the graphical representation takes the form of a diagram that is viewable to a user. In other examples, the graphical representation takes any other suitable form, such as a data structure that is not viewable to the user. For example, the graphical representation can be represented by a data structure G that comprises an ordered pair (N, E), where N comprises a set of nodes and E comprises a set of edges E⊆{{x, y}|x, y ∈ N} that link two discrete nodes.

It can be desirable to represent as many systems and as many connections as possible, and from a perspective as similar as possible to a potential attacker's point of view. However, networks or systems can include a plurality of different elements, each having a different authorization model. Each different authorization model can produce a discrete security graph that represents its own permission scope, or “view” of the relevant graph nodes and edges. In some instances, an attack path can leap from one permission scope to another. Such an attack path can in some cases be invisible from the perspective of any one permission scope. Thus, the discrete security graphs formed using different authorization models can make it difficult to determine the extent of an attacker's penetration into the network or system, and which network or system elements are potentially affected by the attack.

Furthermore, presenting a plurality of such discrete security graphs to a user in visual form can create an incoherent and confusing experience for the user. Analyzing a plurality of such discrete security graphs on a computing device can additionally or alternatively demand more processing power than a single, unified security graph. Furthermore, processing the discrete security graphs can increase a risk of error relative to processing a unified security graph. Exposing a plurality of security graphs representing different customer accounts can also risk exposing these customer accounts to other organizations that share one or more nodes in the plurality of security graphs, which could potentially lead to data breaches.

To address such issues, examples are disclosed that relate to generating an interconnected security graph from two or more security graphs that at least partially overlap. Each security graph comprises a data structure having multiple nodes and at least one edge that connects two or more of the nodes. Each node of the security graphs is classified as a permission scope node or a floating node. For each floating node that matches another floating node, such matching floating nodes are unified into a unified floating node. A set of edges that connects the sorted permission scope nodes and the unified floating nodes is defined based on the at least one edge of each security graph of the two or more security graphs. An interconnected security graph is output comprising the sorted permission scope nodes, the unified floating nodes, and the set of edges. In this manner, the interconnected security graph can be used to identify potential attack paths and/or nodes that could be affected by an attack that span the two or more input security graphs. Furthermore, the interconnected security graph can be further restricted for output to a user that shows a restricted subset of nodes that are within the user's permission scope. Other nodes that are not within the user's permission scope are withheld from the user.

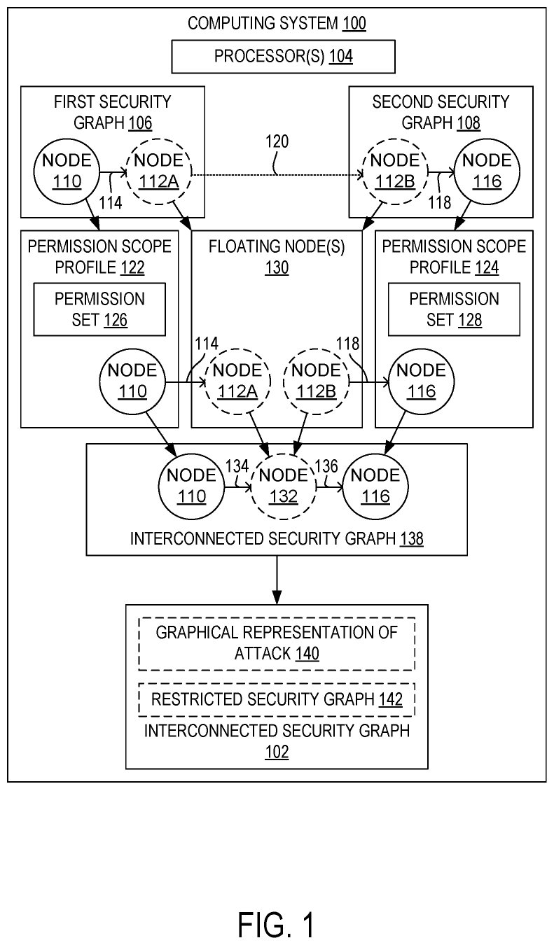

FIG. 1 shows an example of a computing system 100 configured to generate an interconnected security graph 102. In some examples, the computing system 100 comprises one or more server computing devices. In other examples, the computing system 100 can comprise any other suitable type of computing device(s), such as a laptop and/or a desktop computing device.

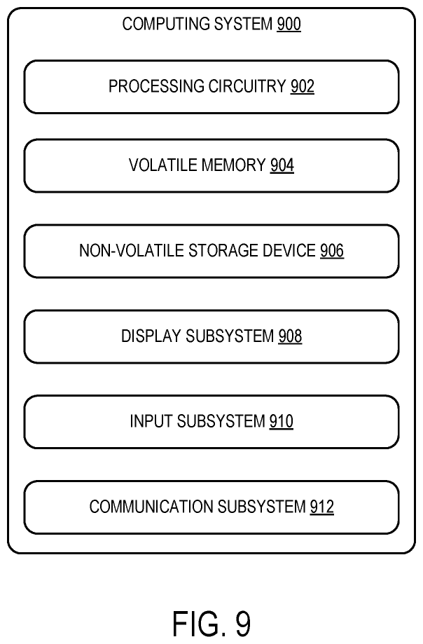

The computing system 100 includes one or more processors 104. The one or more processors 104 can be configured to enact at least a portion of the methods described herein. Additional aspects of the computing system are described in more detail below with reference to FIG. 9.

The computing system 100 is configured to obtain two or more security graphs. In the example of FIG. 1, the computing system 100 is configured to receive, as input, a first security graph 106 and a second security graph 108. Each security graph comprises a data structure defining a plurality of nodes and at least one edge that connects two or more of the plurality of nodes. For example, the first security graph 106 has a first node 110 and a first instance 112A of a second node.

The first security graph 106 and the second security graph 108 at least partially overlap, as the first security graph 106 and the second security graph 108 each include one instance 112A, 112B of the second node. Each instance 112A, 112B of the second node comprises the same element of a network or other system represented by the first security graph 106 and the second security graph 108. For example, each instance 112A, 112B of the second node can be the same secret data file or the same security credential (e.g., a username/password hash). Additional examples of elements that can be represented by the second node are described in more detail below.

The first security graph 106 also has a first edge 114 that connects the first node 110 and the first instance 112A of the second node. In the example of FIG. 1, the second security graph 108 further has a third node 116. The second security graph 108 also includes a second edge 118 that connects a second instance 112B of the second node to the third node 116.

As introduced above, an edge is a link between two discrete nodes. In a directed graph, each edge further comprises an orientation. For example, a set of edges in a directed graph can be represented by E⊆{(x, y)|(x, y) ∈ N}, where (x, y)|(x, y) is an ordered pair of vertices representing locations of two discrete nodes N in a graph. This is in contrast to a non-directed graph, in which each edge can be represented as a non-ordered pair.

The orientation of each edge can be used to represent directionality in a security graph. For example, each edge can represent an input or an output to a connected node. For example, the first edge 114 is depicted in FIG. 1 as a right-facing arrow, which indicates that the first instance 112A of the second node is an output of the first node 110. Similarly, the second edge 118 indicates that the second instance 112B of the second node is an input to the third node 116.

Accordingly, each edge represents a potential security vulnerability between the two or more nodes of each security graph. For example, the first edge 114 represents a potential attack path from the first node 110 to the first instance 112A of the second node. The first edge 114 indicates that, if the first node 110 is compromised, the second node (which is output from the first node 110) can also be compromised. Similarly, the second edge 118 represents a potential attack path from the second instance 112B of the second node to the third node 116. Thus, if the second node is compromised, the third node 116 can also be compromised.

As introduced above, the first security graph 106 and the second security graph 108 do not explicitly indicate that the first instance 112A of the second node and the second instance 112B of the second node are duplicates of the same node. Thus, the first security graph 106 and the second security graph 108 do not reveal a potential attack path 120 between the first node 110 and the third node 116 (through potential compromise of the second node). For example, and as introduced above, each instance 112A, 112B of the second node can represent the same security credential. Thus, if the first node 110, which is configured to output the security credential that grants access to the third node 116, is compromised, an attacker could gain control of the security credential and breach the third node 116. However, as described in more detail below, the interconnected security graph 102 reveals the relationship between these nodes, which can help to prevent or contain such attacks.

In order to generate the interconnected security graph, the computing system 100 is configured to classify each node of the plurality of nodes of the two or more security graphs as a permission scope node or a floating node. In the example of FIG. 1, the first node 110 and the third node 116 are permission scope nodes, as indicated by the solid outline around the first node 110 and the third node 116. Some examples of permission scope nodes include a virtual machine, a database, an application, or a data file. It will also be appreciated by one of ordinary skill in the art, without undue experimentation, that any other network or system element can be represented by a permission scope node. Other examples of permission scope nodes can include a computing device and a storage device.

Each permission scope node 110, 116 is associated with a permission scope profile 122, 124, respectively. Each permission scope profile 122, 124 is associated with a specific set of one or more permissions 126, 128, respectively. The permission sets 126, 128 indicate the extent or boundaries within which a security policy, rule, or system applies. Thus, each permission set defines what is protected, monitored, or controlled by the respective permission scope profile.

In a security graph representing an organization's network, a permission scope of an access control policy can include the specific devices or resources that the policy is configured to control access to.

In a security graph tracking potential threats and incidents, a permission scope of a threat detection algorithm can be a range of behaviors or events the algorithm is configured to monitor, such as unauthorized access attempts or unusual data transfers. When responding to a security incident, the permission scope can encompass affected systems, data, and users that require attention and mitigation.

In other examples, a permission scope can define the range of systems, applications, or data that a particular user or group is allowed to access.

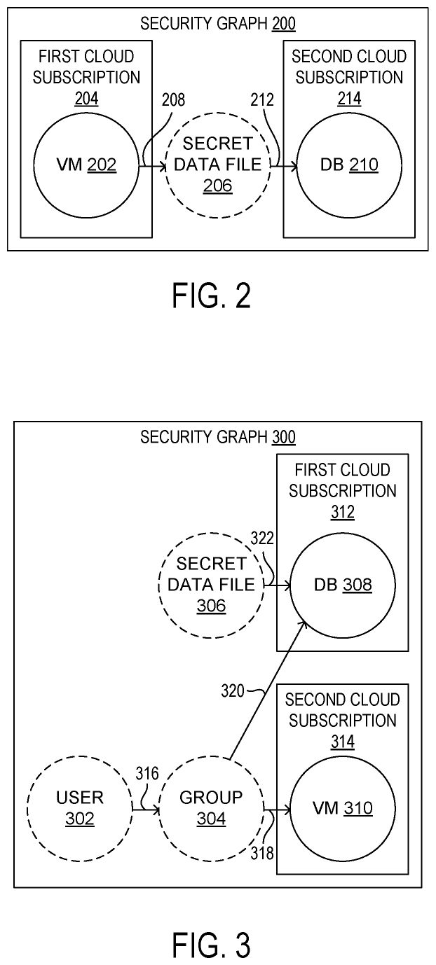

FIG. 2 shows an example of a security graph 200 that includes a permission scope node for a virtual machine 202. The virtual machine 202 is associated with a permission scope for a first cloud service subscription 204. The virtual machine 202 contains a secret data file 206, as indicated by a first edge 208. The secret data file 206 functions as an access credential to grant access to a secure database 210, as indicated by a second edge 212. The secure database 210 is represented in FIG. 2 as a second permission scope node associated with a second cloud subscription 214.

Referring again to FIG. 1, each instance 112A, 112B of the second node is a floating node, as indicated by the dashed outline around each instance of the second node. As described in more detail below, a floating node is not bound to any single set of one or more permissions. In this manner, the floating node can be considered to “float” between permission scopes. Some examples of floating nodes include an access credential, a data file, or a database. It will also be appreciated by one of ordinary skill in the art, without undue experimentation, that any other network or system element can be represented by a floating node. Other examples of floating nodes include a user and a group. In the example of FIG. 2, the secret data file 206 is a floating node.

With reference again to FIG. 1, the computing system 100 is configured to sort each of the permission scope nodes 110, 116 into respective permission scope profiles. The permission scope node 110 is sorted into the first permission scope profile 122. The permission scope node 116 is sorted into the second permission scope profile 124. Each permission scope profile 122, 124 includes one or more permission scope nodes 110, 116 associated with a same set of permissions 126, 128, respectively. In some examples, the first permission scope profile 122 and the second permission scope profile 124 each represent a set of permissions associated with a user account or a group account. For example, the first permission scope profile 122 and the second permission scope profile 124 can represent accounts for the first cloud service subscription 204 of FIG. 2 or the second cloud service subscription 214 of FIG. 2, respectively. The floating nodes 112A, 112B are not specifically tied to either a first set of permissions 126 of the first permission scope profile 122 or a second set of permissions 128 associated with the second permission scope profile 128, and thus remain unsorted as indicated at 130 in FIG. 1.

As introduced above, the first security graph 106 includes a first instance 112A of a floating node and the second security graph 108 includes a second instance 112B of the floating node. The computing system 100 is configured to unify such matching floating nodes into a unified floating node 132. The computing system 100 is also configured to define a set of edges that connects the sorted permission scope nodes 110, 116 and the unified floating node 132. As illustrated in the example of FIG. 1, the set of edges includes a first unified edge 134 and a second unified edge 136. The first unified edge 134 is based on the first edge 114 of the first security graph 106. However, the first unified edge 134 connects the first node 110 to the unified floating node 132, rather than the first instance 112A of the floating node. Similarly, the second unified edge 136 connects the third node 116 to the unified floating node 132, rather than the second instance 112B of the floating node. In this manner, the set of edges reflects unification of the first security graph 106 and the second security graph 108.

The computing system 100 is further configured to output an interconnected security graph 102. It will be appreciated to one of ordinary skill in the art, without undue experimentation, that the interconnected security graph 102 can be output to the computing system 100 itself (e.g., to a storage device, a display device or to an application executed on the computing system 100), or the interconnected security graph 102 can be output to one or more additional computing devices.

The interconnected security graph 102 comprises a unification of the first security graph 106 and the second security graph 108. Accordingly, the interconnected security graph 102 includes the sorted permission scope nodes 110, 116, the unified floating node 132, and the set of edges 134, 136 defined above. In this manner, the interconnected security graph 102 provides a more thorough representation of security relationships (e.g., inputs and outputs) between the nodes than the first security graph 106 and the second security graph 108 alone.

The interconnected security graph 102 enables the computing system 100 to generate a graphical representation 140 of an attack that comprises a path through one or more unified floating nodes. For example, as described above, an attack at the first node 110 could potentially compromise the third node 116 through the second node. The unified floating node 132 enables the extent of the attack to be identified, which allows the computing system 100 to contain and/or mitigate the attack.

In some examples, the computing system 100 is configured to output a restricted security graph 142. In some examples, the restricted security graph 142 is output to a system represented by one or more of the nodes contained within the first security graph 106 and/or the second security graph 108. For example, a restricted security graph can be output to the virtual machine 202 of FIG. 2.

The restricted security graph 142 is a subset of the interconnected security graph 102 that includes one or more nodes connected to the selected node along a restricted path. In this manner, relevant information can be provided about a security environment of the selected node without revealing potential security vulnerabilities of other nodes within the interconnected security graph. The portion of the interconnected security graph 102 that is revealed within the restricted security graph 142 can be determined by traversing the interconnected security graph 102, as described in more detail below with reference to FIGS. 3-7. This is possible since each node in the interconnected security graph 102 is associated with a specific set of permissions 126, 128. The set of permissions associated with a selected node indicates which other nodes are allowed to view or interact with the selected node.

FIG. 3 shows an example of an interconnected security graph 300. The security graph 300 includes a user node 302, a group node 304, and a secret data file 306. The user node 302, the group node 304, and the secret data file 306 are floating nodes, as represented by the dashed outline around each node in FIG. 3. The security graph 300 further comprises a database 308 and a virtual machine 310. The database 308 and the virtual machine 310 are permission scope nodes, as indicated by the solid outline around each node in FIG. 3. The database 308 is associated with a permission scope profile for a first cloud service subscription 312, and the virtual machine 310 is associated with a permission scope profile for a second cloud service subscription 314.

The user 302 is a member of the group 304. This relationship is encoded in the interconnected security graph 300 as a first edge 316. The group 304 has access to the virtual machine 310. This is encoded in the interconnected security graph 300 as a second edge 318. The group 304 also has access to the database 308. This is encoded in the interconnected security graph 300 as a third edge 320. The secret data file 306 also acts as a credential to grant access to the database 308. This is encoded in the interconnected security graph 300 as a fourth edge 322.

In the example of FIG. 3, the interconnected security graph 300 is a directed graph. The nodes 302-310 are connected by directed edges 316-322, as indicated by arrows in FIG. 3. In this example, the arrows reflect directions of access between the nodes 302-310. For example, the user 302 has access to the virtual machine 310 of the second cloud service subscription 314, and the database 308 of the first cloud service subscription 312, through the group 304. However, the user 302 cannot access the secret data file 306 since there is no path from the user 302 to the secret data file 306 without violating the direction of the fourth edge 322.

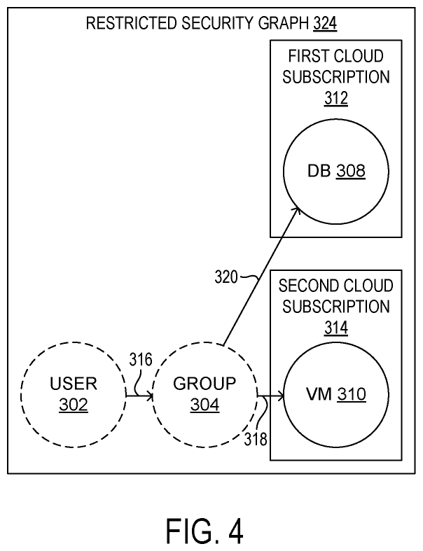

As introduced above, a restricted security graph can be output to a selected node. FIG. 4 shows an example of a restricted security graph 324 for the user 302 that is based on the interconnected security graph 300 of FIG. 3. The restricted security graph 324 of FIG. 4 can be generated by traversing the interconnected security graph 300 of FIG. 3 along a restricted path from the user 302 to thereby identify one or more other nodes (e.g., floating nodes and/or permission scope nodes) connected to the user 302. In the example of FIGS. 3-4, the restricted path comprises a directed path through the graph following a restriction that the edges 316-322 can only be traversed in the direction specified by the arrows in FIG. 3. In this manner, the restricted path allows the interconnected security graph 300 to be traversed in a forward direction (e.g., from the user 302 to the database 308 and the virtual machine 310) and not in a backward direction (e.g., from the database 308 to the secret data file 306). In this manner, the restricted security graph 324 indicates the nodes 302, 304, 308, and 310 that can be viewed and/or accessed by the user 302. However, the restricted security graph 324 omits the secret data file 306 and the edge 322, which are not visible and/or accessible to the user 302.

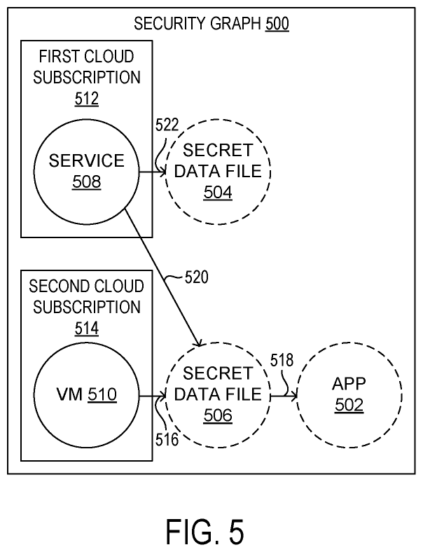

FIG. 5 shows another example of an interconnected security graph 500. The interconnected security graph 500 includes an application 502, a first secret data file 504, and a second secret data file 506. The application 502, the first secret data file 504, and the second secret data file 506 are floating nodes, as represented by the dashed outline around each node in FIG. 5. The security graph 500 further includes a service 508 and a virtual machine 510. The service 508 and the virtual machine 510 are permission scope nodes, as indicated by the solid outline around each node in FIG. 5. The service 508 is associated with a permission scope profile for a first cloud service subscription 512, and the virtual machine 510 is associated with a permission scope profile for a second cloud service subscription 514.

The virtual machine 510 contains the secret data file 506. This relationship is encoded in the interconnected security graph 500 as a first edge 516. The secret data file 506 grants access to the application 502. This is encoded in the interconnected security graph 500 as a second edge 518. The service 508 also has access to the secret data file 506. This is encoded in the interconnected security graph 500 as a third edge 520. The service 508 also contains the secret data file 504. This is encoded in the interconnected security graph 500 as a fourth edge 522.

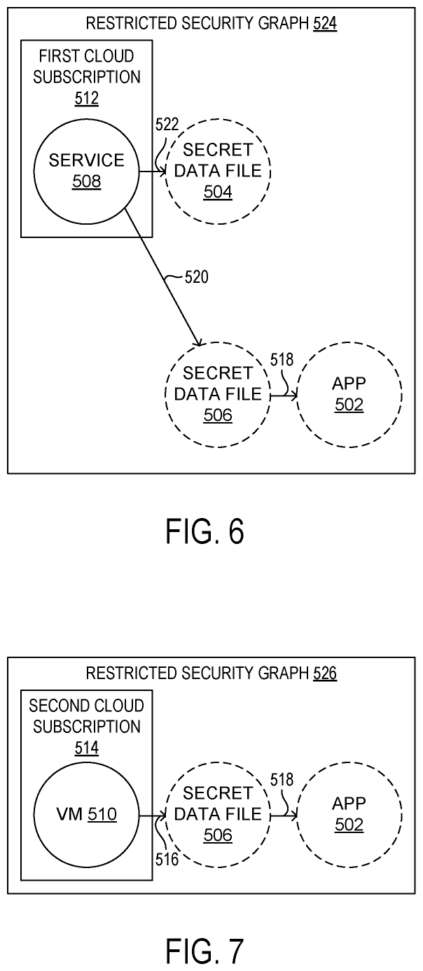

FIG. 6 shows an example of a restricted security graph 524 generated for the service 508 of the first cloud subscription 512. The restricted security graph 524 can be generated by traversing the interconnected security graph 500 of FIG. 5 along a restricted path from the service 508 to thereby identify one or more other nodes (e.g., floating nodes and/or permission scope nodes) connected to the service 508. As indicated in FIG. 6, the restricted security graph 524 includes the nodes 502-508 and the edges 518-522. However, the restricted security graph 524 omits the virtual machine 510 of the second cloud service subscription 514 and the edge 516, which are not visible and/or accessible to the service 508.

FIG. 7 shows another example of a restricted security graph 526 generated for the virtual machine 510 of the second cloud service subscription 514. The restricted security graph 526 shows the virtual machine 510 of the second cloud service subscription 514, the downstream nodes 502, 506, and the downstream edges 516, 518. The restricted security graph 526 omits the service 508, the secret data file 504, and the edges 520, 522, which are not visible and/or accessible to the virtual machine 510.

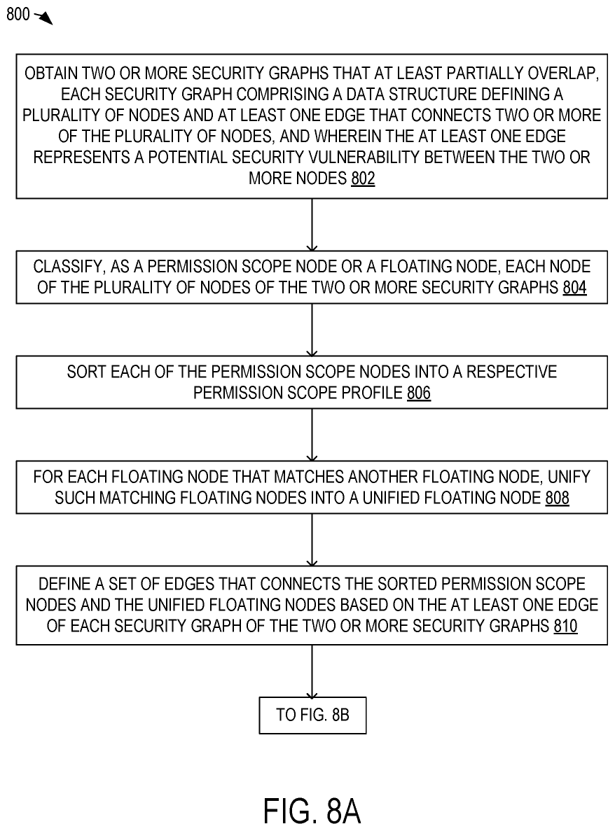

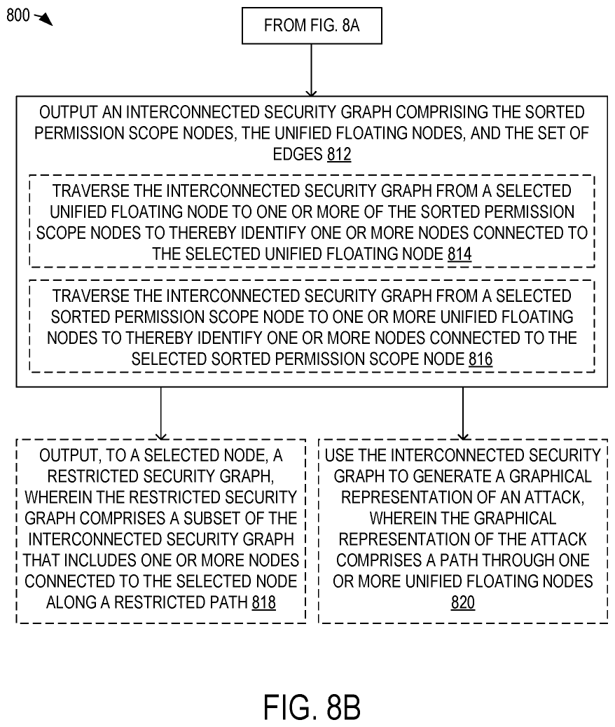

FIGS. 8A-8B shows a flow diagram depicting an example method 800 for generating an interconnected security graph. The following description of the method 800 is provided with reference to FIGS. 1-8 above and FIG. 9 below. It will be appreciated that the method 800 also can be performed in other contexts.

Referring first to FIG. 8A, at 802, the method 800 comprises obtaining two or more security graphs that at least partially overlap, each security graph comprising a data structure defining a plurality of nodes and at least one edge that connects two or more of the plurality of nodes, and wherein the at least one edge represents a potential security vulnerability between the two or more nodes. For example, the computing system 100 is configured to obtain the first security graph 106 and the second security graph 108.

At 804, the method 800 comprises classifying, as a permission scope node or a floating node, each node of the plurality of nodes of the two or more security graphs. For example, the computing system 100 is configured to classify the first node 110 and the third node 116 as permission scope nodes. The first instance 112A of the second node and the second instance 112B of the second node are classified as floating nodes.

The method 800 further comprises, at 806, sorting each of the permission scope nodes into a respective permission scope profile. For example, the computing system 100 of FIG. 1 is configured to sort the first node 110 into the first permission scope profile 122 and to sort the third node 116 into the second permission scope profile 124.

At 808, the method 800 comprises, for each floating node that matches another floating node, unifying such matching floating nodes into a unified floating node. For example, the computing system 100 is configured to unify the first instance 112A and the second instance 112B of the second node into the unified floating node 132. The unified floating node 132 enables the computing system 100 to unite the first security graph 106 and the second security graph 108.

The method 800 further comprises, at 810, defining a set of edges that connects the sorted permission scope nodes and the unified floating nodes based on the at least one edge of each security graph of the two or more security graphs. Referring now to FIG. 8B, at 812, the method 800 comprises outputting an interconnected security graph comprising the sorted permission scope nodes, the unified floating nodes, and the set of edges. For example, the computing system 100 of FIG. 1 is configured to generate and output the interconnected security graph 102.

In some examples, at 814, the method 800 comprises traversing the interconnected security graph from a selected unified floating node to one or more of the sorted permission scope nodes to thereby identify one or more nodes connected to the selected unified floating node. At 816, in some examples, the method 800 comprises traversing the interconnected security graph from a selected sorted permission scope node to one or more unified floating nodes to thereby identify one or more nodes connected to the selected sorted permission scope node. In some examples, at 818, the method 800 comprises outputting, to a selected node, a restricted security graph, wherein the restricted security graph comprises a subset of the interconnected security graph that includes one or more nodes connected to the selected node along a restricted path.

FIG. 3 shows an example of an interconnected security graph 300 that can be traversed from a floating node representing a user 302 to generate the restricted security graph 324 of FIG. 4. FIG. 5 shows an example of a security graph that can be traversed from a permission scope node representing the service 508 or the virtual machine 510 to generate the restricted security graph 524 of FIG. 6 or the restricted security graph 526 of FIG. 7, respectively.

At 820, in some examples, the method 800 comprises using the interconnected security graph to generate a graphical representation of an attack, wherein the graphical representation of the attack comprises a path through one or more unified floating nodes. For example, the interconnected security graph 102 of FIG. 1 can indicate a potential attack path from the first node 110 to the third node 116 through the unified floating node 132. This enables a more thorough visualization of the network or system represented by the first security graph 106 and the second security graph 108 than the first security graph 106 and the second security graph 108 alone.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 9 schematically shows a non-limiting embodiment of a computing system 900 that can enact one or more of the methods and processes described above. Computing system 900 is shown in simplified form. Computing system 900 can embody the computing system 100 described above and illustrated in FIG. 1 Components of computing system 900 may be included in one or more personal computers, server computers, tablet computers, network computing devices, video game devices, mobile computing devices, mobile communication devices (e.g., smartphone), and/or other computing devices.

Computing system 900 includes processing circuitry 902, volatile memory 904, and a non-volatile storage device 906. Computing system 900 may optionally include a display subsystem 908, input subsystem 910, communication subsystem 912, and/or other components not shown in FIG. 9.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 902 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 902.

Non-volatile storage device 906 includes one or more physical devices configured to hold instructions executable by the processing circuitry to implement the methods and processes described herein. When such methods and processes are implemented, the state of non-volatile storage device 906 may be transformed—e.g., to hold different data.

Non-volatile storage device 906 may include physical devices that are removable and/or built in. Non-volatile storage device 906 may include optical memory, semiconductor memory, and/or magnetic memory, or other mass storage device technology. Non-volatile storage device 906 may include nonvolatile, dynamic, static, read/write, read-only, sequential-access, location-addressable, file-addressable, and/or content-addressable devices. It will be appreciated that non-volatile storage device 906 is configured to hold instructions even when power is cut to the non-volatile storage device 906.

Volatile memory 904 may include physical devices that include random access memory. Volatile memory 904 is typically utilized by processing circuitry 902 to temporarily store information during processing of software instructions. It will be appreciated that volatile memory 904 typically does not continue to store instructions when power is cut to the volatile memory 904.

Aspects of processing circuitry 902, volatile memory 904, and non-volatile storage device 906 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via processing circuitry 902 executing instructions held by non-volatile storage device 906, using portions of volatile memory 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 908 may be used to present a visual representation of data held by non-volatile storage device 906. The visual representation may take the form of a graphical user interface (GUI). As the herein described methods and processes change the data held by the non-volatile storage device, and thus transform the state of the non-volatile storage device, the state of display subsystem 908 may likewise be transformed to visually represent changes in the underlying data. Display subsystem 908 may include one or more display devices utilizing virtually any type of technology. Such display devices may be combined with processing circuitry 902, volatile memory 904, and/or non-volatile storage device 906 in a shared enclosure, or such display devices may be peripheral display devices.

When included, input subsystem 910 may comprise or interface with one or more user-input devices such as a keyboard, mouse, touch screen, camera, or microphone.

When included, communication subsystem 912 may be configured to communicatively couple various computing devices described herein with each other, and with other devices. Communication subsystem 912 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 900 to send and/or receive messages to and/or from other devices via a network such as the Internet.

The following paragraphs discuss several aspects of the present disclosure. One aspect provides a computing system, comprising: one or more processors configured to, obtain two or more security graphs that at least partially overlap, each security graph comprising a data structure defining a plurality of nodes and at least one edge that connects two or more of the plurality of nodes, and wherein the at least one edge represents a potential security vulnerability between the two or more nodes; classify, as a permission scope node or a floating node, each node of the plurality of nodes of the two or more security graphs; sort each of the permission scope nodes into a respective permission scope profile; for each floating node that matches another floating node, unify such matching floating nodes into a unified floating node; define a set of edges that connects the sorted permission scope nodes and the unified floating nodes based on the at least one edge of each security graph of the two or more security graphs; and output an interconnected security graph comprising the sorted permission scope nodes, the unified floating nodes, and the set of edges.

Further to this aspect, in some examples, each permission scope profile additionally or alternatively comprises one or more permission scope nodes associated with a same set of permissions.

Further to this aspect, in some examples, the one or more processors are additionally or alternatively configured to traverse the interconnected security graph from a selected unified floating node to one or more of the sorted permission scope nodes to thereby identify one or more nodes connected to the selected unified floating node.

Further to this aspect, in some examples, the one or more processors are additionally or alternatively configured to traverse the interconnected security graph from a selected sorted permission scope node to one or more unified floating nodes to thereby identify one or more nodes connected to the selected sorted permission scope node.

Further to this aspect, in some examples, the one or more processors are additionally or alternatively configured to output, to a selected node, a restricted security graph, wherein the restricted security graph comprises a subset of the interconnected security graph that includes one or more nodes connected to the selected node along a restricted path.

Further to this aspect, in some examples, the interconnected security graph additionally or alternatively comprises a directed graph, and wherein the restricted path comprises a directed path.

Further to this aspect, in some examples, each permission scope profile additionally or alternatively comprises one or more of a user account or a group account.

Further to this aspect, in some examples, each permission scope node additionally or alternatively comprises a virtual machine, a database, an application, or a data file.

Further to this aspect, in some examples, each floating node additionally or alternatively comprises an access credential, a data file, or a database.

Further to this aspect, in some examples, each edge of the interconnected security graph additionally or alternatively indicates an input or an output to a connected node.

Further to this aspect, in some examples, the one or more processors are additionally or alternatively configured to use the interconnected security graph to generate a graphical representation of an attack, wherein the graphical representation of the attack comprises a path through one or more unified floating nodes.

Another aspect provides, at a computing device, a method for generating an interconnected security graph, the method comprising: obtaining two or more security graphs that at least partially overlap, each security graph comprising a data structure defining a plurality of nodes and at least one edge that connects two or more of the plurality of nodes, and wherein the at least one edge represents a potential security vulnerability between the two or more nodes; classifying, as a permission scope node or a floating node, each node of the plurality of nodes of the two or more security graphs; sorting each of the permission scope nodes into a respective permission scope profile; for each floating node that matches another floating node, unifying such matching floating nodes into a unified floating node; defining a set of edges that connects the sorted permission scope nodes and the unified floating nodes based on the at least one edge of each security graph of the two or more security graphs; and outputting an interconnected security graph comprising the sorted permission scope nodes, the unified floating nodes, and the set of edges.

Further to this aspect, in some examples, the method additionally or alternatively comprises traversing the interconnected security graph from a selected unified floating node to one or more of the sorted permission scope nodes to thereby identify one or more nodes connected to the selected unified floating node.

Further to this aspect, in some examples, the method additionally or alternatively comprises traversing the interconnected security graph from a selected sorted permission scope node to one or more unified floating nodes to thereby identify one or more nodes connected to the selected sorted permission scope node.

Further to this aspect, in some examples, the method additionally or alternatively comprises outputting, to a selected node, a restricted security graph, wherein the restricted security graph comprises a subset of the interconnected security graph that includes one or more nodes connected to the selected node along a restricted path.

Further to this aspect, in some examples, the method additionally or alternatively comprises using the interconnected security graph to generate a graphical representation of an attack, wherein the graphical representation of the attack comprises a path through one or more unified floating nodes.

Another aspect provides, a computing system, comprising: one or more processors configured to, obtain two or more security graphs that at least partially overlap, each security graph comprising a data structure defining a plurality of nodes and at least one edge that connects two or more of the plurality of nodes, and wherein the at least one edge represents a potential security vulnerability between the two or more nodes; classify, as a permission scope node or a floating node, each node of the plurality of nodes of the two or more security graphs; sort each of the permission scope nodes into a respective permission scope profile; for each floating node that matches another floating node, unify such matching floating nodes into a unified floating node; define a set of edges that connects the sorted permission scope nodes and the unified floating nodes based on the at least one edge of each security graph of the two or more security graphs; generate an interconnected security graph comprising the sorted permission scope nodes, the unified floating nodes, and the set of edges; traverse the interconnected security graph from a selected node to thereby identify one or more nodes connected to the selected node; and output, to the selected node, a restricted security graph, wherein the restricted security graph comprises a subset of the interconnected security graph that includes the one or more nodes connected to the selected node along a restricted path.

Further to this aspect, in some examples, the one or more processors are additionally or alternatively configured to traverse the interconnected security graph from a selected unified floating node to one or more of the sorted permission scope nodes to thereby identify one or more nodes connected to the selected unified floating node.

Further to this aspect, in some examples, the one or more processors are additionally or alternatively configured to traverse the interconnected security graph from a selected sorted permission scope node to one or more unified floating nodes to thereby identify one or more nodes connected to the selected sorted permission scope node.

Further to this aspect, in some examples, the one or more processors are additionally or alternatively configured to use the interconnected security graph to generate a graphical representation of an attack, wherein the graphical representation of the attack comprises a path through one or more unified floating nodes.

“And/or” as used herein is defined as the inclusive or V, as specified by the following truth table:

| A | B | A ∨ B |
|---|---|---|
| True | True | True |
| True | False | True |
| False | True | True |
| False | False | False |

The terminology “one or more of A or B” as used herein comprises A, B, or a combination of A and B. The terminology “one or more of A, B, or C” is equivalent to A, B, and/or C. As such, “one or more of A, B, or C” as used herein comprises A individually, B individually, C individually, a combination of A and B, a combination of A and C, a combination of B and C, or a combination of A, B and C.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
one or more processors configured to,
obtain two or more security graphs that at least partially overlap, each security graph comprising a data structure defining a plurality of nodes and at least one edge that connects two or more of the plurality of nodes, and wherein the at least one edge represents a potential security vulnerability between the two or more nodes;
classify, as a permission scope node or a floating node, each node of the plurality of nodes of the two or more security graphs;
sort each of the permission scope nodes into a respective permission scope profile;
for each floating node that matches another floating node, unify such matching floating nodes into a unified floating node;
define a set of edges that connects the sorted permission scope nodes and the unified floating nodes based on the at least one edge of each security graph of the two or more security graphs; and
output an interconnected security graph comprising the sorted permission scope nodes, the unified floating nodes, and the set of edges.

2. The computing system of claim 1, wherein each permission scope profile comprises one or more permission scope nodes associated with a same set of permissions.

3. The computing system of claim 1, wherein the one or more processors are further configured to traverse the interconnected security graph from a selected unified floating node to one or more of the sorted permission scope nodes to thereby identify one or more nodes connected to the selected unified floating node.

4. The computing system of claim 1, wherein the one or more processors are further configured to traverse the interconnected security graph from a selected sorted permission scope node to one or more unified floating nodes to thereby identify one or more nodes connected to the selected sorted permission scope node.

5. The computing system of claim 1, wherein the one or more processors are further configured to output, to a selected node, a restricted security graph, wherein the restricted security graph comprises a subset of the interconnected security graph that includes one or more nodes connected to the selected node along a restricted path.

6. The computing system of claim 5, wherein the interconnected security graph comprises a directed graph, and wherein the restricted path comprises a directed path.

7. The computing system of claim 1, wherein each permission scope profile comprises one or more of a user account or a group account.

8. The computing system of claim 1, wherein each permission scope node comprises a virtual machine, a database, an application, or a data file.

9. The computing system of claim 1, wherein each floating node comprises an access credential, a data file, or a database.

10. The computing system of claim 1, wherein each edge of the interconnected security graph indicates an input or an output to a connected node.

11. The computing system of claim 1, wherein the one or more processors are further configured to use the interconnected security graph to generate a graphical representation of an attack, wherein the graphical representation of the attack comprises a path through one or more unified floating nodes.

12. At a computing device, a method for generating an interconnected security graph, the method comprising:
obtaining two or more security graphs that at least partially overlap, each security graph comprising a data structure defining a plurality of nodes and at least one edge that connects two or more of the plurality of nodes, and wherein the at least one edge represents a potential security vulnerability between the two or more nodes;
classifying, as a permission scope node or a floating node, each node of the plurality of nodes of the two or more security graphs;
sorting each of the permission scope nodes into a respective permission scope profile;
for each floating node that matches another floating node, unifying such matching floating nodes into a unified floating node;
defining a set of edges that connects the sorted permission scope nodes and the unified floating nodes based on the at least one edge of each security graph of the two or more security graphs; and
outputting an interconnected security graph comprising the sorted permission scope nodes, the unified floating nodes, and the set of edges.

13. The method of claim 12, further comprising traversing the interconnected security graph from a selected unified floating node to one or more of the sorted permission scope nodes to thereby identify one or more nodes connected to the selected unified floating node.

14. The method of claim 12, further comprising traversing the interconnected security graph from a selected sorted permission scope node to one or more unified floating nodes to thereby identify one or more nodes connected to the selected sorted permission scope node.

15. The method of claim 12, further comprising outputting, to a selected node, a restricted security graph, wherein the restricted security graph comprises a subset of the interconnected security graph that includes one or more nodes connected to the selected node along a restricted path.

16. The method of claim 12, further comprising using the interconnected security graph to generate a graphical representation of an attack, wherein the graphical representation of the attack comprises a path through one or more unified floating nodes.

17. A computing system, comprising:
one or more processors configured to,
obtain two or more security graphs that at least partially overlap, each security graph comprising a data structure defining a plurality of nodes and at least one edge that connects two or more of the plurality of nodes, and wherein the at least one edge represents a potential security vulnerability between the two or more nodes;
classify, as a permission scope node or a floating node, each node of the plurality of nodes of the two or more security graphs;
sort each of the permission scope nodes into a respective permission scope profile;
for each floating node that matches another floating node, unify such matching floating nodes into a unified floating node;
define a set of edges that connects the sorted permission scope nodes and the unified floating nodes based on the at least one edge of each security graph of the two or more security graphs;
generate an interconnected security graph comprising the sorted permission scope nodes, the unified floating nodes, and the set of edges;
traverse the interconnected security graph from a selected node to thereby identify one or more nodes connected to the selected node; and
output, to the selected node, a restricted security graph, wherein the restricted security graph comprises a subset of the interconnected security graph that includes the one or more nodes connected to the selected node along a restricted path.

18. The computing system of claim 17, wherein the one or more processors are further configured to traverse the interconnected security graph from a selected unified floating node to one or more of the sorted permission scope nodes to thereby identify one or more nodes connected to the selected unified floating node.

19. The computing system of claim 17, wherein the one or more processors are further configured to traverse the interconnected security graph from a selected sorted permission scope node to one or more unified floating nodes to thereby identify one or more nodes connected to the selected sorted permission scope node.

20. The computing system of claim 17, wherein the one or more processors are further configured to use the interconnected security graph to generate a graphical representation of an attack, wherein the graphical representation of the attack comprises a path through one or more unified floating nodes.
